(19) United States
(12) Patent Application Publication
(10) Pub. No.: US 2022/0034812 A1
(43) Pub. Date: Feb. 3, 2022

(54) OPTICAL ARRANGMENT FOR FLUORESCENCE MICROSCOPY APPLICATIONS

(71) Applicants: FRAUNHOFER-GESELLSCHAFT ZUR FÖRDERUNG DER ANGEWANDTEN FORSCHUNG E.V., München (DE); Friedrich-Schiller-Universitaet Jena, Jena (DE)

(72) Inventors: Markus GRAEFE, Jena (DE); Marta GILABERTE BASSET, Jena (DE); Falk EILENBERGER, Jena (DE); Frank SETZPFAND, Jena (DE)

(73) Assignees: Fraunhofer-Gesellschaft Zur Foerderung Angewandten Forschung E.V., Muenchen (DE); Friedrich-Schiller-Universitaet Jena, Jena (DE)

(21) Appl. No.: 17/275,704

(22) PCT Filed: Sep. 12, 2019
(86) PCT No.: PCT/EP2019/074338

§ 371 Date: Mar. 12, 2021

(30) Foreign Application Priority Data
Sep. 18, 2018 (DE) 10 2018 215 831.2

(51) Int. Cl. G01N 21/64; G02B 21/00; G02B 21/36

(52) U.S. Cl. CPC G01N 21/6458; G02B 21/367; G02B 21/0076

(57) ABSTRACT

An optical arrangement for fluorescence microscopy applications. Electromagnetic radiation from a radiation source is directed onto a biological sample in the form of a light sheet. One of more fluorophore(s) is contained in the sample. The radiation photoactivates the fluorophore(s) by exciting them from a state which they cannot be exited to fluoresce to a state which they can be exited to fluoresce by illuminating with electromagnetic radiation of a particular wavelength, and subsequently photodeactivating them. Multiphoton beams of nonclassical light are directed onto a first optical system the beam(s) are directed onto a sample of the light sheet. Fluorescent radiation of fluorophores, can be excited within the light sheet by the plurality of multiphoton beams occurring simultaneously on/in the sample. The fluorescence radiation occurs by means of a second optical system on a detection system which measures in a spatially resolving manner.

### BACKGROUND OF THE INVENTION

The invention relates to an optical arrangement for fluorescence microscopy applications using non-classical light. The field of application is fluorescence microscopy and multiphoton absorption analysis. This is of great importance, for example, for the microscopic examination of bio-chemical samples in the life sciences and medicine, but also for chemical/material analysis investigations of substances.

The excitation and detection of fluorescent light is carried out by means of multiphoton, in particular two-photon absorption of multiphoton states or photon pairs for applications that can be carried out analogously to fluorescence microscopy.

There are already various approaches to solving this problem, but they all have fundamental disadvantages. In principle, these known solutions can be divided into three categories:

a. Two-photon fluorescence microscopy using classical light as disclosed in U.S. Pat. No. 5,503,613 B and U.S. Pat. No. 6,020,591 B. Two-photon absorption is realized by means of continuous wave lasers with very high intensity or by pulsed lasers with pulses in the picosecond or femtosecond range. The two-photon absorption probability and thus also the fluorescence intensity depend quadratically on the instantaneous excitation intensity. The exciting laser radiation is focused to improve the absorption probability. In classical two-photon fluorescence microscopy, the focus is formed axially along the optical axis of the system. The fluorescent molecules can only be excited by two-photon absorption and thus show fluorescence when they are focussed. However, the entire sample area along the optical axis is exposed to a high radiation dose and correspondingly high energy. This leads to both fluorescence bleaching and phototoxicity, especially in biological samples.

b. An alternative solution is the two-photon light sheet mode. Here, the focus of the excitation radiation is formed as a plane—called a light sheet—perpendicular to the direction of observation. For this purpose, the sample to be examined is laterally illuminated by a suitable optical system. The light sheet can be formed by a line focus, line image, or a laterally scanning laser beam. Only in this light sheet can fluorescent molecules be excited by two-photon absorption and thus show fluorescence. The disadvantage of this method is the necessity of illumination with very high intensity continuous wave lasers or laser systems for ultra-short laser pulses. In both cases, the sample is irradiated with high intensity laser radiation or even laser pulses and exposed to a high dose of irradiation with high energy. This leads to both fluorescence bleaching and phototoxicity, especially in biological samples. Here, too, the two-photon absorption probability and thus also the fluorescence intensity depend quadratically on the instantaneous excitation intensity.

c. Photon pair fluorescence microscopy possibilities are also known from U.S. Pat. No. 5,796,477 B. Here, two-photon absorption is not excited by high-intensity or pulsed lasers, but by photon pairs consisting of two correlated (in space, time, momentum and/or energy) photons. In particular, these can be generated by spontaneous differential frequency conversion in a nonlinear crystal outside the sample. The two photons can be spatially separated from each other as they move from the photon pair source to the respective sample. If they have a different wavelength, this can be achieved with a dichroic mirror. If they have opposite polarization, they can be spatially separated by a polarization beam splitter. However, it is equally possible that both photons leave a crystal with nonlinear optical properties in a spatially separated manner and are thus already spatially separated. The two photon beams are then focused into the sample in a crossed manner. In the overlap region of the photons meeting at the focus, two-photon absorption can then take place. In this scenario, the two-photon absorption and thus the fluorescence intensity are linearly proportional to the instantaneous excitation intensity. Another advantage is that the focal volume can be smaller compared to the method described under a. The disadvantage of this method is the complex experimental setup, since it must be ensured that both photons of a pair arrive in the beam overlap volume at exactly the same time and collide within the sample. This may be complicated by the very short coherence time and possibly different but correlated wavelength of the two photons. Therefore, a very precise adjustment, at the expense of flexibility and practicality, is required.

### SUMMARY OF THE INVENTION

It is therefore the object of the invention to provide possibilities for fluorescence microscopy with which the local energy input during fluorescence excitation can be reduced and with which a simple optical setup with reduced adjustment effort can be used.

According to the invention, this object is achieved with an optical arrangement having the features of the claims.

In the arrangement according to the invention, electromagnetic radiation is directed from a radiation source onto a biological sample to form a one- or two-dimensional light sheet. At least one fluorophore is present in the sample. Here, the electromagnetic radiation of at least two wavelengths is selected to photoactivate or photodeactivate the fluorophore(s), depending on the wavelength of the electromagnetic radiation. In a photoactivation, the fluorophore(s) is/are photoactivated from a state in which they cannot be excited to fluoresce (dark state) to a state in which they can be excited to fluoresce (bright state) by illumination with electromagnetic radiation of a specific wavelength and subsequently photoactivated in which the fluorophore(s) is/are photoactivated from a state in which they can be excited to fluoresce (bright state) to a state in which they cannot be excited to fluoresce (dark state) by illumination with electromagnetic radiation of another specific wavelength within the light sheet.

One or more multiphoton beam(s), but at least one or two photon pair beam(s), is/are directed from a source of non-classical light towards a first optical system consisting of an arrangement of at least one optical lens or a photon reflecting element or a polarizing optical element, or an optical filter, or a combination thereof. The multiphoton beam(s) is/are directed from the first optical system onto a sample in the region of the light sheet so that fluorescence radiation from the fluorophore(s) is excited by multiphoton absorption with the multiple multiphoton states impinging simultaneously on/in the sample.

Fluorescence is thus only excited when fluorescence-activating electromagnetic radiation and a multiphoton beam impinge simultaneously on one position of a sample.

Fluorescence radiation obtained by excitation impinges, by means of a second optical system, on a detection system designed for spatially resolved detection of fluorescence radiation.

The method proposed here is based on the use of a preferably collinear source from which, in particular, photon pairs or also multiphoton states are emitted simultaneously onto a sample and the principle of light sheet microscopy is applicable, as well as an additional formation of a light sheet with electromagnetic radiation in the area of the sample. A light sheet can be formed one-dimensionally as a line or two-dimensionally as an irradiated surface. Here, photoactivation and deactivation of the fluorophores prevents fluorescence from being excited outside the light sheet region of the multiphoton beams.

A source of non-classical light emits multiphoton beams, but at least one or two photon pair beams of in particular photon pairs or but also multiphoton states, preferably in collinear geometry into the region of the formed light sheet. This can be achieved by spontaneous differential frequency conversion/spontaneous parametric fluorescence in a nonlinear and periodically poled optical crystal or a waveguide structure in a nonlinear crystal. The multiphoton beam(s) passes through a first optical system onto a sample so that fluorescence of the fluorophores can be excited, which can be detected by the detection system in a location-triggered manner and then evaluated.

The light sheet or the light sheet-like shape can be formed as a temporally constant line focus but also as a light beam scanned in the light sheet plane or composed by the temporal sequence of small partial light sheets. A first optical system suitable for this purpose may be an optical lens or an optical element reflecting the electromagnetic radiation. A light sheet may be formed, for instance, by a movement of at least one optical element or an optical element that increases the cross-sectional area of the beam of electromagnetic radiation to which the electromagnetic radiation emitted from the radiation source is directed.

Radiation should be emitted from the radiation source at a wavelength specific to the particular fluorophore used for photoactivation and deactivation. In particular, the radiation source may be one or more laser beam sources. In addition, the light sheet forming source may also include an optical lens or photon reflecting element or polarizing optics or optical filter or any arrangement of more than one of these optical elements.

For example, autofluorescent molecules or molecular fluorescent markers, such as Green Fluorescence Protein (GFP) or DAPI, can be used as fluorophores.

A first optical system may be an optical lens or a photon reflecting element or a polarizing optic or an optical filter or any arrangement of more than one of these optical elements.

Only in the area of the sample with the photoactivating wavelength that is transilluminated by the light sheet or the light sheet-like form is simultaneous absorption of several photons, in particular of photon pairs, and thus fluorescence excitation possible. A part of the fluorescence radiation will impinge on a detection system with optional use of a second optical system and will be detected there. The second optical system may be an optical lens, or a fluorescent radiation reflecting element, or a polarizing optic, or an optical filter, or any arrangement of more than one of these optical elements. A detector system should render possible spatially resolved measurement of the fluorescence radiation excited within the light sheet. The detector system can be a camera with sufficient sensitivity. Examples are a CCD, EMCCD, ICCD, CMOS camera, SPAD array. It may include an optical filter or a second optical system. The second optical system and the detection system can also be designed as a unit.

In another embodiment of the invention, multiple photon beams can also be used so that fluorescence can be excited simultaneously in multiple light sheets or in regions having a light sheet-like shape on the sample. The excitation of fluorescence can also be done explicitly via multiphoton absorption of multiphoton states, especially pairs of photons impinging simultaneously on a sample. Such multiphoton states can be realized e.g. by so-called N00N states, in which case N-photon absorption takes place.

A source of nonclassical light may be, for example, a laser-pumped nonlinear crystal, or a laser-pumped nonlinear crystal or waveguide structure in a nonlinear crystal, or at least two identical coherently pumped quantum dots.

A modified variant consists in splitting the photon pair beam into two partial beams, which can be achieved, for example, by a dichroic mirror or a polarization beam splitter. The partial beams are separated and then directed into/onto the sample, crossing each other, by a first optical system, which is in particular an arrangement of lenses and/or mirrors. In addition, multiple photon pair beams can be used so that fluorescence can be excited at multiple positions simultaneously. It is also possible to combine these photon pair beams to obtain a single photon pair beam and excite fluorescence on a point-by-point basis. In another embodiment, in contrast to point-by-point imaging as previously described, a two-dimensional region in which photon pairs can be generated at each point can be imaged onto the sample in the region transilluminated by the light sheet or a light sheet-like region, thereby generating two-photon absorption and hence fluorescence in this region. This can be achieved, for example, by mapping the surface of a nonlinear crystal, in which the photon pairs are generated, onto the sample.

The solution according to the invention has several advantages over the prior art for fluorescence microscopy using multiphoton absorption. Since the fluorescence intensity scales linearly with the instantaneous illumination intensity, the irradiation dose of the sample can be reduced while maintaining the signal yield, or the signal strength and image contrast of the fluorescence radiation detected by the detection system can be increased while maintaining the irradiation dose. The method is thus maximally gentle, without unnecessary light exposure of the sample, and thus allows long-term studies of photosensitive samples, as both fluorescence bleaching and phototoxicity can be minimized. In contrast to photon pair fluorescence microscopy, the setup is significantly simplified and more robust, so that a cost reduction and improvement of the axial resolution can be achieved. The collinear setup is compatible and implementable with existing light sheet and fluorescence microscope systems. In addition, photon pair radiation with photons of a certain center wavelength can be focused to focal volumes which otherwise can only be reached with laser light of half the wavelength. This can increase the resolution of the detectable fluorescence radiation within the particular light sheet in which photoactivation occurs. Overall, increased efficiency, increased spatial resolution and increased penetration depth are possible. Likewise, the linear relationship between fluorescence intensity and photon beam intensity is advantageous for data evaluation, since there is a linear relationship between the measure and (fluorescence signal) and the excitation quantity (radiation dose).

### DESCRIPTION OF THE DRAWING

In the following, the invention will be explained in more detail by way of an example.

In the drawing:

FIG. 1 schematically shows an example of an arrangement according to the invention.

### DETAILED DESCRIPTION OF THE DRAWING

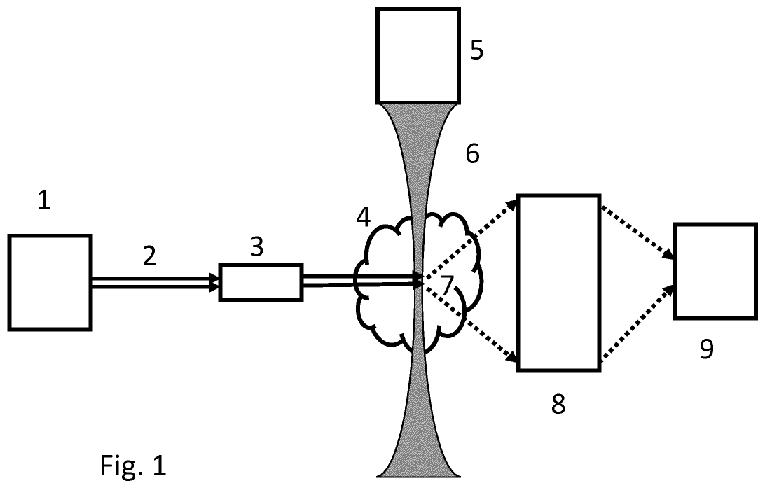

FIG. 1 shows how a photon pair beam 2 from a collinear source 1 of non-classical light is directed towards a first optical system 3. The first optical system 3 may be configured as defined in the claims.

The photon pair beam 2 influenced by the first optical system 3 is directed onto/into the sample 4 in such a way that it impinges on the sample 4 in the region of a light sheet or enters the sample 4. A light sheet is formed by means of a radiation source 5, from which electromagnetic radiation 6 is directed onto the sample 4. The biological sample is a fluorescent sample containing at least one fluorophore. The electromagnetic radiation 6 has one wavelength for photoactivating the fluorophore or fluorophores, and may emit a second wavelength after fluorescence is detected to photodeactivate the fluorescence. Fluorescence excitation of the fluorophore occurs when multiple photons from source 1 simultaneously impinge on the sample 4 or enter sample 4. With the formation of a light sheet alone, the fluorophores within the light sheet are photoactivated or photodeactivated after fluorescence imaging.

The change in the position at which photons reach the sample 4 can be achieved by a movement of an element reflecting the photons, in particular by means of a pivoting movement about a rotation axis of a reflecting element.

With photon pairs impinging on the sample 4 or entering the sample 4, excitation of fluorescent radiation 7 within the light sheet is achieved.

The generated fluorescent radiation 7 is incident on a second optical system 8, which is also configured as defined in the claims. The detector system 9 is used for spatially resolved detection of fluorescence radiation, which can be evaluated by fluorescence microscopy.

1. An optical arrangement for fluorescence microscopy applications, in which electromagnetic radiation from a radiation source is directed onto a biological sample in the form of a light sheet and one or more fluorophores are contained in the sample, wherein the electromagnetic radiation photoactivates the fluorophore(s) by exciting them from a state in which they cannot be excited to fluoresce into a state in which they can be can be excited to fluoresce by illumination with electromagnetic radiation of a particular wavelength and subsequently photodeactivating them from a state in which they can be excited to fluoresce into a state in which they cannot be can be excited to fluoresce by illumination with electromagnetic radiation of another particular wavelength,
one or more multiphoton beams, and at least one or two photon pair beams are directed from a source of non-classical light onto a first optical system consisting of an arrangement of at least one optical lens or photon reflecting element or polarizing optical element, or optical filter or a combination thereof, and
directed, from there to a sample in the region of the light sheet, such that fluorescence radiation of the one fluorophore or the fluorophores in the state in which they can be excited to fluoresce is excited with the several multiphoton beams incident simultaneously on/in the sample by means of multiphoton absorption within the light sheet, and
fluorescence radiation obtained by excitation is incident, by means of a second optical system, on a detection system which is designed for spatially resolved detection of fluorescence radiation.

2. The arrangement according to claim 1, wherein the source of nonclassical light is a nonlinear crystal pumped by a laser or waveguide structure in a nonlinear crystal, or at least two identical coherently pumped quantum dots.

3. The arrangement according to claim 1, wherein the one or more multiphoton beams, but the at least one or more photon pair beams in collinear geometry, are directed towards the first optical system.

4. The arrangement according to claim 1, wherein the fluorescence radiation can be excited with two photons in the form of a photon pair.

5. The arrangement according to claim 1, wherein the radiation source emits at least two different wavelengths, at least one for photoactivation and at least one for photodeactivation, of the respective fluorophore(s).

6. The arrangement according to claim 1, wherein the radiation source is an optical system consisting of an arrangement of at least one optical lens or a photon reflecting element or a polarizing optical element, or an optical filter or a combination thereof.

7. The arrangement according to claim 1, wherein the formation of the light sheet is achieved by a movement of at least one optical element or an optical element increasing the beam cross-sectional area of the electromagnetic radiation onto which the electromagnetic radiation emitted by the radiation source is directed.

8. The arrangement according to claim 1, wherein the first optical system is used to linearly change the position of incidence of the at least one multiphoton beam on/in the sample, so that a corresponding line-shaped region of at least one line is irradiated at least once.

9. The arrangement according to claim 1, wherein a multiphoton beam emitted by the source is split into a plurality of partial beams and the partial beams are directed onto/into the sample by means of at least one first optical system for exciting fluorescence in the region of the light sheet.

10. The arrangement according to claim 1, wherein a plurality of partial beams are directed onto the sample to intersect one another on/in the sample.

11. The arrangement according to claim 1, wherein fluorescence can be excited simultaneously with a plurality of photon pair beams at a plurality of positions, or a single photon pair beam can be obtained with a plurality of photon pair beams combined with one another, and fluorescence can thus be excited point-by-point.

12. The arrangement according to claim 1, wherein a one- or two- or three-dimensional movement of the sample is performed for spatially resolved imaging of the sample.

13. The arrangement according to a claim 1, wherein the first optical system or the second optical system have a nonlinear optical crystal, an optical lens, a photon reflecting element, a polarization optics, an optical filter or an arrangement of a plurality of these optical elements.

14. The arrangement according to claim 1, wherein the detection system is a CCD, an EMCCD, an ICCD or a CMOS camera or a SPAD array.
